(19) United States
(12) Patent Application Publication
(10) Pub. No.: US 2026/0064506 A1
(43) Pub. Date: Mar. 5, 2026

(54) SYSTEM AND METHOD FOR PROGNOSTIC-BASED DYNAMIC TASK ALLOCATION IN A MULTI-AGENT AUTONOMOUS SYSTEM

(71) Applicant: Richard Joseph Mitchell, TAVARES, FL (US)

(72) Inventor: Richard Joseph Mitchell, TAVARES, FL (US)

(21) Appl. No.: 19/381,718

(22) Filed: Nov. 6, 2025

(51) Int. Cl. G06F 11/00; G06F 9/48

(52) U.S. Cl. CPC G06F 11/004; G06F 9/4856; G06F 2201/805

(57) ABSTRACT

A system and method for fail-operational mission continuity in a multi-agent autonomous system. Each autonomous agent includes an onboard Prognostic Health Management (PHM) module that monitors health using sensor data. Upon detecting an incipient fault, the PHM module calculates a prognostic Remaining Useful Life (RUL). This RUL is transformed into a quantitative Operational Risk Cost (Ω) and communicated to a multi-agent control system. The control system's dynamic task allocation algorithm uses the Ω values as key inputs in a multi-objective optimization process. This enables the system to proactively and autonomously re-allocate a task from a degrading agent to a healthy agent before a failure occurs. The degrading agent is simultaneously commanded to perform a safe contingency maneuver. This integration of real-time prognostics and multi-agent control creates a resilient, self-healing system capable of completing missions despite hardware degradation.

### BACKGROUND OF THE INVENTION

### 1. Technical Field

The present invention relates generally to the field of autonomous and robotic systems control. More specifically, it pertains to a computer-implemented system and method for improving mission reliability and achieving fail-operational behavior in a multi-agent autonomous system by synergistically integrating real-time prognostic health data into a dynamic task allocation framework, thereby enabling proactive re-tasking of mission objectives away from degrading agents before a critical failure occurs.

### 2. Background Art

The operational paradigm for uncrewed and autonomous systems is rapidly advancing towards complex, large-scale deployments where fleets of coordinated agents, often referred to as swarms, execute missions with minimal human supervision. Regulatory frameworks, such as the proposed FAA Part 108, anticipate scenarios where a single human operator may oversee dozens or even hundreds of uncrewed aircraft systems (UAS) performing tasks like large-scale infrastructure inspection, persistent surveillance, precision agriculture, or logistics and package delivery. The technical and commercial viability of such operations is critically dependent on achieving unprecedented levels of system autonomy, reliability, and resilience.

A significant technical challenge in managing these multi-agent systems is ensuring mission continuity in the face of individual agent hardware degradation and failure. The prior art in multi-agent task allocation has produced sophisticated algorithms for coordinating healthy agents to perform complex tasks efficiently. These systems often frame task allocation as a multi-objective optimization problem, seeking to minimize metrics such as total mission time (makespan), energy consumption, or operational cost. Techniques including Mixed-Integer Linear Programming (MILP), genetic algorithms like NSGA-II, auction-based mechanisms, and consensus algorithms are employed to distribute workloads and schedule tasks among the agents in the fleet. However, a fundamental limitation of these conventional systems is that they typically operate under the assumption that all agents are, and will remain, fully functional throughout the mission. Their fault tolerance is almost exclusively reactive; they respond to a catastrophic failure (e.g., a motor seizure or complete power loss) by detecting the agent's abrupt absence from the network and then attempting to re-plan the mission with the remaining assets. This reactive approach is inadequate for safety-critical or time-sensitive missions where the sudden, uncontrolled loss of an agent is unacceptable and can lead to mission failure or collateral damage.

For example, U.S. Pat. No. 6,990,406 B2 describes a multi-agent system focused on coordination between surface and air assets but lacks any mechanism for integrating prognostic health data for proactive re-tasking. Similarly, U.S. Patent Application Publication No. 2022/0223056 A1 discloses methods for managing UAV task allocation but does not incorporate real-time Remaining Useful Life (RUL) estimates to enable fail-operational behavior. These systems, while effective at optimizing for performance, inadvertently create what can be termed a “brittle swarm.” By pushing each agent to its operational limits to maximize efficiency, these optimization algorithms accelerate component wear and increase the probability of unforeseen failures. The conventional cost functions are blind to the dimension of accumulated component stress or wear, creating a hidden technical problem where the optimization process itself contributes to the system's fragility. An agent may be deemed the “optimal” choice for a high-stress maneuver based on its location and energy reserves, but executing that maneuver might consume a significant fraction of its remaining motor bearing life, a cost that prior art systems cannot quantify or act upon in real-time.

Concurrently, the separate technical field of Prognostics and Health Management (PHM) has developed advanced methods for monitoring the health of individual complex systems. PHM systems utilize sensor data to detect incipient faults-subtle signs of degradation that precede a functional failure—and to estimate a component's or system's Remaining Useful Life (RUL). This prognostic information is invaluable for condition-based maintenance, allowing for the scheduling of repairs before a failure occurs. However, in the prior art, this RUL data is typically siloed within the maintenance domain. It is generated post-mission or used for long-term planning and is not integrated as a real-time input for autonomous, operational decision-making at the multi-agent mission control level.

Therefore, a significant technical gap exists in the art. There is an unmet need for a system that bridges the domains of real-time PHM and multi-agent dynamic task allocation. No existing system integrates real-time prognostic health data, such as RUL, directly into the control loop of a multi-agent system to enable proactive, autonomous re-tasking. This capability is essential for transforming a brittle, reactive swarm into a truly “fail-operational” fleet that can intelligently manage the health of its constituent agents to maintain mission objectives despite the inevitable degradation of individual hardware components. Such a technical leap is a prerequisite for the safe, reliable, and scalable autonomous operations of the future.

### BRIEF SUMMARY OF THE INVENTION

The present invention provides a system and method that overcomes the aforementioned limitations of the prior art by providing a technical solution to the problem of mission continuity in multi-agent systems. The disclosed invention creates a fail-operational, self-healing multi-agent fleet by synergistically integrating an onboard, real-time prognostic health assessment for each agent with a health-aware, multi-agent dynamic task allocation control system. The invention transforms the fleet from a collection of individually optimized but brittle units into a cohesive, resilient system that can gracefully handle impending failures without human intervention, thereby improving the functionality and safety of the underlying multi-agent control technology.

In one aspect, the invention provides a computer-implemented method for dynamic task allocation. The method comprises, for each of a plurality of autonomous agents, monitoring its operational health using onboard sensors. An onboard Prognostic Health Management (PHM) module, which includes a processor, calculates a prognostic Remaining Useful Life (RUL) for its host agent upon detection of an incipient fault. This RUL is then transformed, by a processor, into a quantitative Operational Risk Cost (Ω), which serves as a formal metric of the agent's fitness for continued mission-critical operations. This risk cost Ω is communicated in real-time from the agent to a multi-agent control system. The control system, executing a multi-objective optimization algorithm, autonomously re-allocates a mission task from a first agent with a high-risk cost to a second, healthier agent with a lower risk cost. This re-allocation is based at least in part on the respective 2 values of the agents, ensuring that mission-critical tasks are always handled by the most reliable assets available.

In another aspect, the invention provides a system for providing fail-operational capability in a multi-agent fleet. The system comprises a plurality of autonomous agents, each equipped with sensors and an onboard PHM module. The PHM module is configured to analyze sensor data to estimate an RUL and transform the RUL into the quantitative Operational Risk Cost (Ω). The system further comprises a multi-agent control system, which may be centralized or distributed, that is communicatively coupled to the plurality of agents. The control system includes a processor and a memory storing a Health-Aware Dynamic Task Allocation module. This module is specifically configured to receive the Ω values from each agent and to use these values as a primary input parameter in a multi-objective optimization process. When the Ω of a first agent exceeds a predetermined, mission-specific threshold, the module is configured to autonomously re-assign the first agent's task to a second, more suitable agent and, concurrently, to command the first agent to execute a safe contingency maneuver, such as returning to a base or landing in a safe location.

The core technical innovation is the creation of a real-time feedback loop between the prognostic health state of individual agents and the collective, system-level task allocation logic. By formalizing the RUL as a quantitative Operational Risk Cost (Ω) and incorporating this cost directly into the multi-objective optimization function of the task allocator, the system's primary objective function is dynamically shifted from pure efficiency to a balanced consideration of efficiency and mission reliability. This proactive, health-aware control strategy solves the “brittle swarm” problem inherent in the prior art and enables the fleet to maintain mission objectives despite the degradation of individual hardware components, representing a significant technical advance in the field of autonomous systems control.

### BRIEF DESCRIPTION OF THE SEVERAL VIEWS OF THE DRAWING

FIG. 1 is a system architecture diagram illustrating an exemplary fail-operational multi-agent system, showing a plurality of autonomous agents, each with an onboard Prognostic Health Management (PHM) module, in communication with a multi-agent control system.

FIG. 2 is a data and control flow diagram illustrating the real-time feedback loop of the present invention, showing sensor data from an agent feeding into its PHM module, the resulting Remaining Useful Life (RUL) and Operational Risk Cost (Ω) being transmitted to the multi-agent control system, and the control system issuing re-tasking and contingency commands to the agents.

FIG. 3 is a process flowchart detailing the logic of the autonomous mission re-tasking protocol, from the continuous monitoring and detection of an incipient fault to the successful handoff of tasks and execution of a contingency maneuver.

FIG. 4 is a state transition diagram for two agents within the system, illustrating a first agent transitioning from a “Nominal” state to a “Degrading” state and then to an “Executing Contingency” state, while a second agent transitions from a “Nominal” state to an “Assuming Re-tasked Mission” state.

FIG. 5 is a conceptual block diagram of the multi-objective optimization function within the Health-Aware Dynamic Task Allocation Algorithm, illustrating the integration of the novel Operational Risk Cost (Ω) alongside conventional cost inputs such as time, energy, and distance.

### DETAILED DESCRIPTION OF THE INVENTION

Reference will now be made in detail to exemplary embodiments of the invention, examples of which are illustrated in the accompanying drawings. Wherever possible, the same reference numbers will be used throughout the drawings to refer to the same or like parts.

### I. System Architecture and Operating Environment

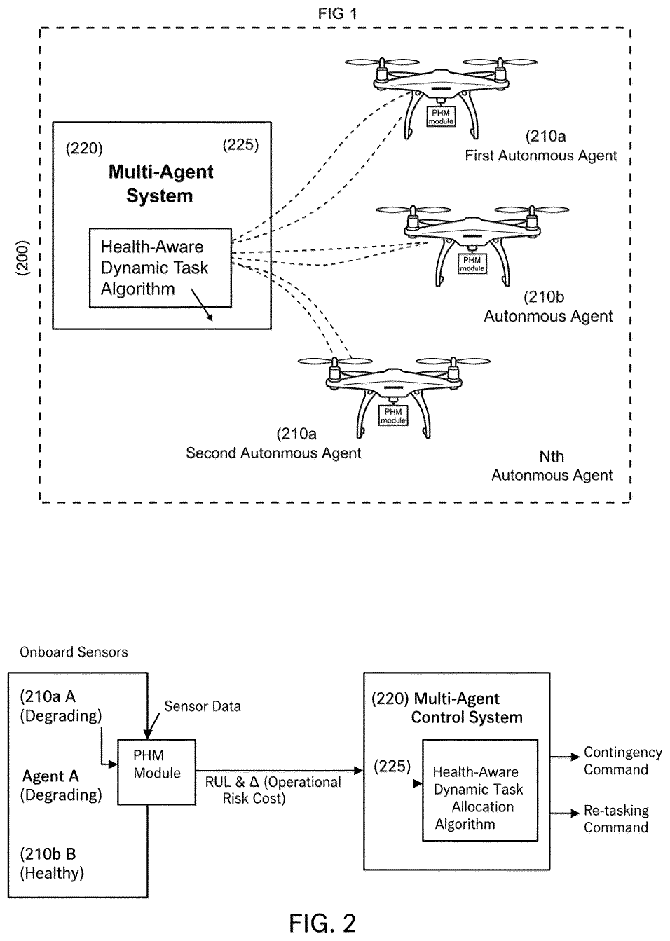

Referring to FIG. 1, an exemplary embodiment of the Fail-Operational Multi-Agent System (200) is shown. The system (200) comprises a plurality of Autonomous Agents (210) (e.g., (210a), (210b), (210n)) and a Multi-Agent Control System (220). The autonomous agents (210) may be any type of robotic or autonomous vehicle, including but not limited to Uncrewed Aerial Vehicles (UAVs) such as quadcopters or fixed-wing drones, autonomous ground vehicles (AGVs), autonomous surface vehicles (ASVs), or autonomous underwater vehicles (AUVs). The agents (210) may be homogeneous (all of the same type) or heterogeneous (a mix of different types). Each agent (210) comprises a chassis, one or more propulsion systems (e.g., electric motors, propellers), a power source (e.g., a battery), a suite of navigation sensors (e.g., Global Positioning System (GPS) receiver, Inertial Measurement Unit (IMU)), a mission-specific payload (e.g., a camera, a package delivery mechanism), and an onboard computer. The onboard computer includes at least one processor and a memory, and is configured to execute flight control and navigation software.

Crucially, each autonomous agent (210) is equipped with an onboard Prognostic Health Management (PHM) Subsystem, hereinafter referred to as the PHM module (215). The PHM Module (215) is communicatively coupled to a variety of health-monitoring sensors integrated into the agent's critical components.

The multi-agent control system (220) is responsible for the high-level mission planning, coordination, and task allocation for the entire fleet of agents (210). The control system (220) comprises at least one processor and a memory storing instructions for a Health-Aware Dynamic Task Allocation Algorithm (225). The control system (220) is communicatively coupled to the agents (210) via a wireless communication network (e.g., Wi-Fi, cellular, satellite). In some embodiments, the control system (220) is centralized, residing on a ground control station or a cloud-based server. In other embodiments, the control system (220) is distributed, with its functions and logic executed in a peer-to-peer fashion across the onboard computers of the agents (210) themselves, thereby avoiding a single point of failure. The principles of the present invention are applicable to both centralized and distributed control architectures.

### II. Onboard Prognostic Health Management (PHM) Subsystem

The PHM module (215) resident on each autonomous agent (210) functions as an intelligent, real-time health monitoring and prediction subsystem. It provides the critical prognostic data that enables the proactive decision-making of the overall system (200).

### A. Sensor Data Acquisition

The PHM module (215) is communicatively coupled to and receives data streams from a suite of onboard sensors specifically chosen to monitor the state of critical, failure-prone components. Non-limiting examples of such sensors include:
Vibration Sensors: High-frequency accelerometers or piezoelectric sensors mounted on or near propulsion motors, gearboxes, or structural members to detect changes in vibration signatures indicative of bearing wear, imbalance, or crack propagation.
Current and Voltage Sensors: Hall effect sensors or shunt resistors to monitor the current draw and voltage of batteries and electric motors. Anomalies such as increased current draw for a given thrust output can indicate motor inefficiency or bearing friction.
Temperature Sensors: Thermocouples or thermistors to monitor the temperature of batteries, motors, and power electronics. Overheating is a common precursor to failure.

Actuator Feedback Sensors: Encoders or potentiometers on control surface actuators (e.g., servos) to monitor their position, speed, and responsiveness. Sluggish or inaccurate responses can indicate impending actuator failure.

### B. RUL Estimation Embodiments

The PHM Module (215) processes the incoming time-series data from these sensors to first detect an incipient fault and then to estimate the Remaining Useful Life (RUL) of the degrading component or the agent as a whole. The RUL is a time-based or usage-based prediction of how long the agent can be expected to continue operating before a functional failure occurs.

To satisfy the written description and enablement requirements of 35 U.S.C. § 112, several non-limiting embodiments for the RUL estimation algorithm are disclosed.
Embodiment 1: Machine Learning models: In a preferred embodiment, the PHM module (215) utilizes a machine learning model specifically configured for time-series analysis and prediction. Suitable models include Recurrent Neural Networks (RNNs), and more specifically, Long Short-Term Memory (LSTM) or Gated Recurrent Unit (GRU) networks. These models are trained offline using historical sensor data collected from components that were run to failure in a controlled environment. The input to the trained model during operation is a sliding window of recent multi-sensor data, and the output is a direct prediction of the RUL. For example, an LSTM network can be trained to recognize the evolving spectral density patterns in vibration data that precede a motor bearing failure and map these patterns to a remaining operational time.
Embodiment 2: Physics-Based Models: In an alternative embodiment, the PHM module (215) may employ a physics-of-failure model. For instance, a particle filter or a Kalman filter can be used to track the state of a degradation process, such as the growth of a crack in a propeller blade. The model would use vibration data as an observation to update its belief about the current crack size and then use a known material fatigue model (e.g., Paris' law) to project the time until the crack reaches a critical length, thereby estimating RUL. This approach is particularly useful when a well-understood physical model of the failure mechanism exists.

The output of the PHM module (215) is a continuously updated RUL value, which is the key input for the next stage of the system.

### III. Health-Aware Dynamic Task Allocation Subsystem

The Health-Aware Dynamic Task Allocation Algorithm (225), executed by the control system (220), represents the core of the inventive system's decision-making logic. It fundamentally differs from prior art task allocators by integrating the prognostic health data from the PHM modules (215) as a primary control variable.

### A. Formulation of the Multi-Objective Optimization Problem

The task allocation problem is formulated as finding an optimal policy, π*, that maps a set of tasks to the set of agents to minimize a global cost function, J. In conventional systems, this cost function is a weighted sum of performance-related objectives:

$${J}_{conventional} = {w}_{1} {J}_{time} + {w}_{2} {J}_{energy} + {w}_{3} {J}_{safety}$$

where Jₜᵢₘₑ represents the total mission time or makespan, J_{energy} represents the total energy consumed by the fleet, J_{safety} represents a cost associated with collision risks, and wᵢ are weighting factors.

The present invention introduces a novel term into this optimization problem, the Operational Risk Cost, Ω. The new, health-aware global cost function, J_{health-aware}, is formulated as:

$${J}_{health - aware} = {w}_{1} {J}_{time} + {w}_{2} {J}_{energy} + {w}_{3} {J}_{safety} + {w}_{4} {\sum }_{i = 1}^{N} {Ω}_{i}$$

where N is the number of agents and Ωᵢ is the individual Operational Risk Cost for agent i. This formulation explicitly directs the optimization algorithm to find solutions that not only are efficient in terms of time and energy but also minimize the overall risk of mission failure due to agent degradation. This is conceptually illustrated in FIG. 5, which shows the Ω input (510), derived from the RUL (505), being fed into the multi-objective optimization engine (520) alongside traditional cost inputs (515).

### B. The Operational Risk Cost Function (Ω)

A key aspect of the invention is the transformation of the raw RUL estimate into a mathematically well-defined Operational Risk Cost (Ω). This transformation avoids ambiguity and provides a concrete, computable metric that can be directly used by an optimization algorithm. This moves beyond mere “cost function hacking” and provides a principled method for risk-based control. Several non-limiting embodiments for defining Ω are disclosed.
Embodiment 1: Inverse Function: A straightforward method is to define the risk cost as an inverse function of the RUL:

$${Ω}_{i} = \frac{k}{{RUL}_{i}}$$

where Ωᵢ is the risk cost for agent i, RULᵢ is its estimated Remaining Useful Life, and k is a mission-specific scaling factor. This formulation provides a simple, monotonically increasing cost as the agent's health degrades, effectively penalizing unhealthy agents in the optimization process. An agent with a very high RUL has a risk cost approaching zero.
Embodiment 2: Probabilistic Cost: A more sophisticated approach, rooted in probabilistic risk assessment, defines the risk cost as the expected cost of failure for a given task.

$${Ω}_{i} ( Δ t ) = {P}_{fail , i} ( Δ t ) \times {C}_{fail}$$

Here, Ωᵢ(Δt) is the risk cost for agent i to perform a task of expected duration Δt. C_{fail} is a predefined cost associated with a catastrophic failure (e.g., loss of the agent, failure of the mission). P_{fail,i}(Δt) is the probability that agent i will fail within the time interval Δt. This probability can be derived from the RUL estimate, for example, by modeling the time-to-failure with a statistical distribution, such as a Weibull distribution, whose parameters are informed by the RUL. This method allows the system to assess risk in the context of specific task durations.
Embodiment 3: Coherent Risk Metric (Conditional Value-at-Risk): For safety-critical applications, Ω can be defined using a coherent risk metric, such as Conditional Value-at-Risk (CVaR). Coherent risk metrics provide a more rational assessment of risk by being sensitive to the tails of cost distributions, i.e., low-probability, high-consequence events. Let Xᵢ be a random variable representing the total mission cost, which is highly dependent on the health of agent i. The risk cost for agent i can be formulated as:

$${Ω}_{i} = {CVaR}_{α} ( {X}_{i} \vert {RUL}_{i} )$$

This represents the expected cost in the worst (1−α) % of cases, given the current RUL of agent i. Using CVaR allows the system to optimize for robustness against worst-case failure scenarios, which is a more nuanced approach than simply optimizing against the expected (average) outcome.

By providing these concrete mathematical formulations, the invention is clearly distinguished from an abstract idea and is enabled for a person skilled in the art to practice without undue experimentation.

### C. Exemplary Task Allocation Algorithms

The novel Operational Risk Cost (Ω) can be incorporated into various known task allocation algorithms. The following non-limiting embodiments illustrate how the invention can be practiced across different control architectures.
Centralized Embodiment (Modified NSGA-II): In a centralized architecture, a multi-objective evolutionary algorithm such as the Non-dominated Sorting Genetic Algorithm II (NSGA-II) can be employed. The algorithm is modified to treat the minimization of the total operational risk, ΣΩᵢ, as a distinct objective, alongside minimizing makespan and energy consumption. Instead of producing a single optimal solution, NSGA-II generates a Pareto front of solutions. Each point on the front represents a different trade-off between mission performance and mission risk. A human supervisor or an automated higher-level policy can then select the solution that best meets the current mission priorities.
Distributed Embodiment (Health-Weighted Auction): In a distributed architecture, a market-based or auction mechanism can be used. When a new task becomes available, the control system (or a designated auctioneer agent) broadcasts the task. Each agent i computes a bid, Bᵢ, to win the task. The bid is a function of its suitability for the task (e.g., based on proximity, capability, and available resources) but is explicitly penalized by its health status. A health-weighted bid can be formulated as:

$${B}_{i} = \frac{{Score}_{i}}{1 + {w}_{Ω} {Ω}_{i}}$$

where Scoreᵢ represents the agent's raw suitability and w_{Ω} is a weighting factor for the risk cost. The task is awarded to the agent with the highest bid. This decentralized mechanism naturally disincentivizes unhealthy agents from taking on new tasks, as their high Ωᵢ value will suppress their bids.
Distributed Embodiment (Consensus-Based Subgradient): Another distributed approach involves using a consensus-based optimization algorithm, such as a distributed projected subgradient method. In this framework, each agent maintains a local version of the overall mission plan and iteratively communicates with its neighbors to converge on a globally optimal solution that minimizes the global cost function, J_{health-aware}. Each agent's local update step takes into account its own risk cost, Ωᵢ. Through repeated local computations and communications, the entire fleet converges on a task allocation that is both efficient and health-aware, without requiring a central controller.

TABLE 1
Comparison of Exemplary Embodiments

| | Embodiment 1: | Embodiment 2: | Embodiment 3: |
|---|---|---|---|
| | Centralized | Distributed | Distributed |
| Feature | (NSGA-II) | (Auction) | (Consensus) |
| Architecture | Centralized | Distributed | Distributed |
| | Controller | (Market-Based) | (Cooperative) |
| Optimality | Global (Pareto | Local (Greedy), | Global |
| | Optimal Front) | near-optimal | (Converges |
| | | | to optimum) |
| Computational | High on Central | Low, distributed | Medium, |
| Load | Controller | among agents | distributed |
| | | | iterative |
| Communication | High (All-to-one) | Medium | High |
| | | (Broadcast & | (Peer-to-peer |
| | | Bid) | iterative) |
| Scalability | Limited by | High | Moderate |
| | controller | | |
| Fault | Single point | Robust | Robust |
| Tolerance | of failure | to agent loss | to agent loss |

### IV. Operational Process Flow

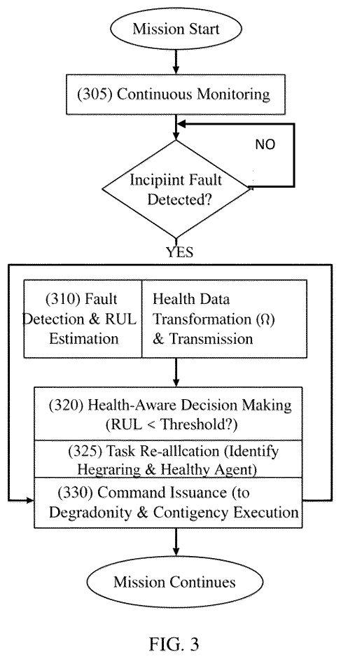

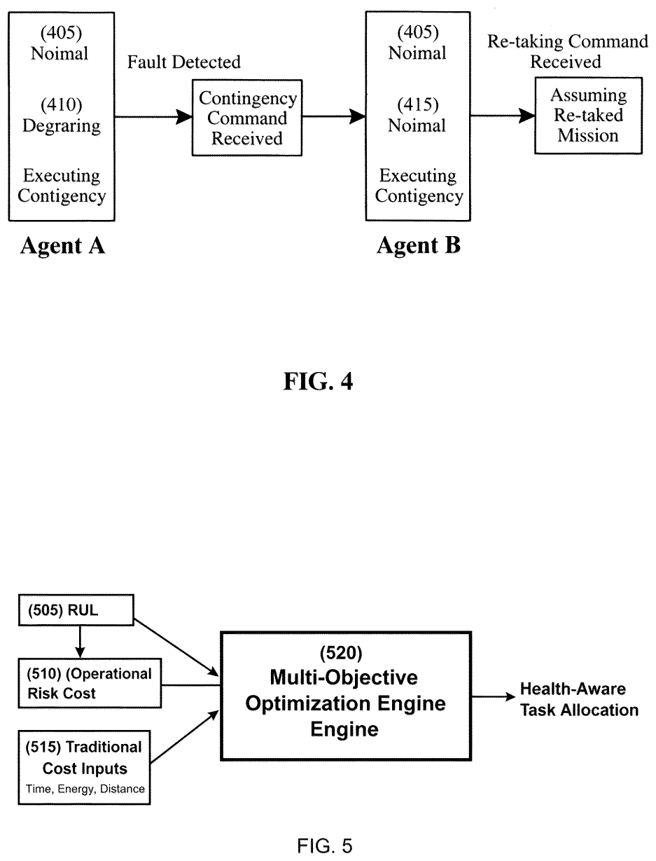

The overall process of maintaining mission continuity is illustrated in the flowchart of FIG. 3 and the state transition diagram of FIG. 4. The following provides a detailed, step-by-step walkthrough of the operation, enriched with the technical specifics previously described.
1. Continuous Monitoring (Step 305): An autonomous agent, Agent A (210a), is performing its assigned mission task (e.g., surveying a section of a pipeline). Its onboard PHM Module (215a) is continuously processing data from its sensors. For example, its LSTM network is analyzing high-frequency vibration data from an accelerometer mounted on motor #3. Agent A is in the “Nominal” state (405).
2. Fault Detection & RUL Estimation (Step 310): The PHM Module (215a) detects a subtle but persistent deviation in the vibration signature of motor #3, consistent with the early stages of bearing degradation. This constitutes the detection of an incipient fault. Upon detection, the PHM module's algorithm computes an RUL for the motor, estimating it to be 30 minutes of operational flight time. Agent A transitions to the “Degrading” state (410).
3. Health Data Transformation and Transmission (Step 315): The PHM module (215a) transforms the 30-minute RUL into the quantitative Operational Risk Cost, Ω_{A}. Using the probabilistic cost formulation (Embodiment 2), and knowing the cost of failure C_{fail}, it calculates a high Ω_{A} for any task requiring more than a few minutes of flight. Agent A (210a) transmits its updated status, including its ID, position, current task, RUL, and the calculated Ω_{A}, to the Multi-Agent Control System (220) via the communication network.
4. Health-Aware Decision Making (Step 320): The Control System (220) receives the health update from Agent A (210a). It compares the received RUL of 30 minutes against a pre-defined, mission-specific safety threshold (e.g., 60 minutes). Since the RUL is below the threshold, The Health-Aware Dynamic Task Allocation Algorithm (225) is triggered to initiate a proactive re-tasking protocol.
5. Task Re-allocation (Step 325): The Health-Aware Algorithm (225) re-solves the multi-objective optimization problem for the entire fleet. It seeks a new task allocation that minimizes the global cost function J_{health-aware}. The algorithm identifies Agent B (210b) as the optimal candidate to take over Agent A's task. This selection is based on a multi-objective assessment considering Agent B's proximity, current workload, energy level, and, crucially, its very high RUL and correspondingly near-zero risk cost, Ω_{B}. The low Ω_{B} ensures the reliability of the reassigned task.
6. Command Issuance (Step 330): The Control System (220) issues two new commands concurrently via the communication network:
To Agent A (210a): “Abort current task. Execute pre-defined contingency maneuver C-1 (Return-to-Base).”
To Agent B (210b): “Proceed to [coordinates of Agent A's former task area] and assume [Agent A's former task].”
7. Mission Continuity and Contingency Execution (Step 335): Agent A (210a) receives its command, terminates its surveying task, and transitions to the “Executing Contingency” state (415), proceeding along a safe path back to its designated recovery point. Simultaneously, Agent B (210b) receives its new tasking, transitions from its “Nominal” state (405) to the “Assuming Re-tasked Mission” state (420), and proceeds to take over Agent A's responsibilities. The overall mission objective is achieved without interruption, failure, or the need for human intervention.

### V. Alternative Embodiments and Use Cases

The principles of the present invention are not limited to the specific embodiments described. The system and method can be applied to a wide range of scenarios. For example, the fleet may be heterogeneous, comprising both aerial and ground agents. The Health-Aware Algorithm (225) can allocate a surveillance task from a degrading UAV to a healthy ground robot if their capabilities overlap.

The invention is also applicable to domains beyond uncrewed vehicles. In industrial automation, a fleet of robotic arms on an assembly line could use the same principles. A robotic arm with a degrading actuator (detected by its PHM module) could have its tasks proactively re-assigned to a neighboring healthy arm, preventing a line stoppage. Similarly, in satellite constellations, tasks could be re-allocated from a satellite with degrading reaction wheels to another satellite in the constellation.

Furthermore, the set of contingency maneuvers is not limited to “return-to-base.” Depending on the agent, mission, and severity of the degradation, other pre-planned maneuvers may be commanded, such as landing at the nearest designated safe recovery site, moving to a loiter pattern in a safe, unpopulated area, or, in extreme cases, jettisoning a payload in a pre-approved safe zone before attempting a controlled landing.

What is claimed is:

1. A computer-implemented method for dynamic task allocation in a multi-agent system, the method comprising:
a. calculating, by a first processor of a first autonomous agent from a plurality of autonomous agents, a prognostic Remaining Useful Life (RUL) for the first autonomous agent based on time-series sensor data received from one or more sensors onboard the first autonomous agent, wherein calculating the RUL is performed by a Long Short-Term Memory (LSTM) network trained on historical sensor degradation profiles;
b. transforming, by the first processor, the calculated RUL into a quantitative Operational Risk Cost (Ω), wherein the quantitative Operational Risk Cost (Ω) is a Conditional Value-at-Risk (CVaR) metric representing an expected cost in a worst-case percentage of failure scenarios, calculated based on the RUL;
c. communicating the quantitative Operational Risk Cost (Ω) from the first autonomous agent to a multi-agent control system; and
d. autonomously re-allocating, by a second processor of the multi-agent control system executing a Non-dominated Sorting Genetic Algorithm II (NSGA-II), a mission task from the first autonomous agent to a second autonomous agent from the plurality of autonomous agents, wherein the NSGA-II algorithm is configured to treat minimization of the CVaR metric as a distinct objective and wherein the re-allocation is based at least in part on the quantitative Operational Risk Cost (Ω) of the first autonomous agent and a quantitative Operational Risk Cost (Ω) of the second autonomous agent.

2. The method of claim 1, further comprising commanding, by the multi-agent control system, the first autonomous agent to execute a pre-defined contingency maneuver subsequent to the re-allocation of the mission task.

3. The method of claim 2, wherein the pre-defined contingency maneuver is a return-to-base maneuver.

4. The method of claim 1, wherein the re-allocation is triggered when the calculated RUL of the first autonomous agent falls below a mission-specific safety threshold.

5. The method of claim 1, wherein the time-series sensor data is received from at least one of a motor vibration sensor, a battery voltage sensor, a current draw sensor, a temperature sensor, or an actuator position feedback sensor.

6. The method of claim 1, wherein the NSGA-II algorithm is further configured to generate a Pareto front of solutions representing trade-offs between minimizing the CVaR metric and minimizing at least one of mission time or energy consumption.

7. The method of claim 1, wherein the autonomous agents are uncrewed aircraft systems (UAS).

8. A system for providing fail-operational capability in a multi-agent fleet, the system comprising:
a. A plurality of autonomous agents, each autonomous agent comprising:
i. one or more sensors for monitoring an operational health of the autonomous agent; and
ii. a first processor and a first memory storing a prognostic health management (PHM) module, the PHM module configured to:
receive time-series sensor data from the one or more sensors;
calculate a prognostic Remaining Useful Life (RUL) for the autonomous agent based on the time-series sensor data using a Long Short-Term Memory (LSTM) network; and
transform, using the first processor, the calculated RUL into a quantitative Operational Risk Cost (Ω), wherein the quantitative Operational Risk Cost (Ω) is a Conditional Value-at-Risk (CVaR) metric;
b. A multi-agent control system communicatively coupled to the plurality of autonomous agents, the multi-agent control system comprising a second processor and a second memory storing a health-aware dynamic task allocation module;
wherein the health-aware dynamic task allocation module is configured to:
i. receive the quantitative Operational Risk Cost (Ω) from each of the plurality of autonomous agents; and
ii. autonomously re-assign a mission task from a first autonomous agent to a second autonomous agent by executing a Non-dominated Sorting Genetic Algorithm II (NSGA-II) that uses the quantitative Operational Risk Costs (Ω) as input parameters to identify a re-assignment that minimizes the CVaR metric as a distinct objective.

9. The system of claim 8, wherein the multi-agent control system is further configured to command the first autonomous agent to perform a return-to-base maneuver concurrently with the re-assignment of the mission task.

10. The system of claim 8, wherein the health-aware dynamic task allocation module is configured to trigger the re-assignment when the quantitative Operational Risk Cost (Ω) of the first autonomous agent exceeds a predetermined threshold.

11. The system of claim 8, wherein the LSTM network is trained on historical sensor degradation profiles collected from components run to failure in a controlled environment.

12. The system of claim 8, wherein the CVaR metric represents an expected cost in a worst-case percentage of failure scenarios, calculated based on the RUL.

13. The system of claim 8, wherein the one or more sensors comprise a motor vibration sensor and a battery voltage sensor.

14. A non-transitory computer-readable medium having instructions stored thereon, that when executed by one or more processors, cause the one or more processors to perform a method for dynamic task allocation in a multi-agent system, the method comprising:
a. receiving, from a first autonomous agent from a plurality of autonomous agents, a quantitative Operational Risk Cost (Ω), wherein the quantitative Operational Risk Cost (Ω) is a Conditional Value-at-Risk (CVaR) metric derived from a prognostic Remaining Useful Life (RUL), the RUL being calculated by a first processor of the first autonomous agent using a Long Short-Term Memory (LSTM) network based on onboard sensor data;
b. receiving quantitative Operational Risk Costs (Ω) from other autonomous agents in the plurality of autonomous agents; and
c. executing a Non-dominated Sorting Genetic Algorithm II (NSGA-II) that uses the received quantitative Operational Risk Costs (Ω) as input parameters to determine a re-allocation of a mission task from the first autonomous agent to a second autonomous agent, wherein the NSGA-II algorithm treats minimization of the CVaR metric as a distinct optimization objective.

15. The non-transitory computer-readable medium of claim 14, the method further comprising:
commanding the first autonomous agent to execute a return-to-base maneuver subsequent to the determination of the re-allocation.
